(19) United States
(12) Patent Application Publication
(10) Pub. No.: US 2023/0383886 A1
(43) Pub. Date: Nov. 30, 2023

(54) SOUND REDUCER AND METHOD OF MAKING SAME

(71) Applicant: Umfotec Acoustic Solutions GmbH, Northeim (DE)

(72) Inventors: Ralf Buck, Kipfenberg/Schelldorf (DE); Berend Linke, Noerten-Hardenberg (DE); Viktor Hurlebaus, Northeim (DE)

(21) Appl. No.: 18/033,124

(22) PCT Filed: Nov. 1, 2021
(86) PCT No.: PCT/EP2021/080248

§ 371 Date: Apr. 21, 2023

(30) Foreign Application Priority Data
Nov. 16, 2020 (DE) 10 2020 130 205.3

(51) Int. Cl. F16L 55/027; G10K 11/16; G10K 11/172

(52) U.S. Cl. CPC F16L 55/027; G10K 11/161; G10K 11/172

(57) ABSTRACT

A sound reducer (10) includes a housing (12) having a jacket (122) extending longitudinally along and rotationally symmetrical about a housing axis. Two end walls (123) are aligned transverse to the housing axis main pipe (18) and penetrating the housing (12) parallel offset to the housing axis with windows (182) formed as pipe wall openings. The main pipe (20) is sealingly fixed in passages penetrating the end walls (123). The end walls (123) have a convex base curvature that is rotationally symmetrical with the housing axis and, in the region of the passages, merge into outwardly pointing pipe sockets (16) that project in one piece and in one material from the respective end wall (123). Annular transition regions (14) are curved concavely in deviation from the convex base curvature with a radius that is at least 1/15 of the radius of the convex curvature of the base curvature.

### BACKGROUND

### Field of Invention

The invention relates to a sound reducer comprising a housing having a jacket extending longitudinally along and rotationally symmetrical about a housing axis and further having two end walls aligned transversely to the housing axis, and a main pipe penetrating the housing parallel offset to the housing axis with windows formed as pipe wall openings, wherein the main pipe is fixed sealingly in passages penetrating the end walls. The invention further relates to a method of manufacturing a sound reducer.

### Prior Art

Generic sound reducers are known from DE 10 2018 101 380 A1.

Sound reducers are generally known for a variety of purposes and based on different operating principles. The sound reducer disclosed in the above-mentioned publication, like the sound reducer according to the invention, operates essentially according to the principle of the so-called Helmholtz resonator. A possible field of application of such sound reducing resonators is in the area of exhaust gas lines of motor vehicles as well as in the area of refrigerant circuits in air conditioning systems. The fluid in question, for example exhaust gas or refrigerant, flows through a main pipe that passes through a resonator housing. The passages of the resonator housing are connected in a sealing manner to the outer wall of the main pipe. Inside the resonator housing, the main pipe has window-like pipe wall openings through which its interior is fluidically connected to the interior of the housing. The shape and position of the windows, together with the size of the resonator chamber formed by the housing, determine those frequencies of the sound conducted by the fluid or generated in the fluid that are reduced by the Helmholtz effect in the sound reducer. To increase the spectrum of reducible frequencies, it is known from the aforementioned publication to divide the resonator chamber into two partial chambers by using a partition wall that divides the housing into two axial sections of different sizes. The partition wall has a through opening with which the partition wall is slid onto the main pipe and sealingly connected to the outer wall of the main pipe at a suitable position. The outer edge of the partition wall abuts against the inner wall of the housing. From the aforementioned patent document, it is known to allow the main pipe to run eccentrically, parallel to the axis of symmetry of the rotationally symmetrical housing jacket. This asymmetrical design, together with specially placed holes in the pipe wall of the main pipe, allows oil introduced into the resonator chamber with the fluid to be extracted. The housing of the known sound reducer has a strictly cylindrical shape. The main pipe passes through straight vertical end walls, to which the main pipe is sealingly connected. As a rule, an annular weld is required to seal the passages.

A similar sound reducer with an eccentrically positioned main pipe passing through vertical end walls is known from FR 2 871 547 A1. A special feature of this sound reducer is that—depending on the design—either the main pipe or the jacket has a conical shape, deviating from a purely cylindrical geometry.

The known sound reducers are not optimal in several respects. On the one hand, a considerable material thickness of the housing must be provided to create sufficient pressure resistance, which is associated with disadvantageously high costs and high weight. In addition, welding the main pipe to the passages in the end walls of the housing involves a time-consuming work step.

U.S. Pat. No. 3,141,519 discloses a sound reducer that has a pressure vessel-like basic shape consisting of a cylindrical jacket and convexly curved end faces. This sound reducer has a hollow interior subdivided by means of several axially spaced partition walls perpendicular to the axial direction. The partition walls have central apertures concentric with the jacket. A common axial rod passes through the central apertures and closure elements are fixed axial rod. The closure elements can gradually close central apertures in the partition walls depending on the axial position of the axial rod. On one side, the axial rod protrudes centrally through one of the side walls in order to be able to interact there with an externally accessible axial adjustment device, by means of which the axial position of the axial rod and thus the effect of the sound reducer can be adjusted. The air is supplied and discharged via axially parallel pipe sockets formed eccentrically from the end walls. In particular, the radially inner section of the transition region forms an acute angle to the convex base curvature of the respective end face, relative to the end faces.

DE 10 2005 005 865 A1 describes a sound reducer whose resonator housing, like its main pipe, is formed from two axially assembled sections. At their point of contact, the main pipe sections merge into a radially outwardly extending annular wall that is fixed between the facing edges of the housing sections during assembly. In this way, the main pipe can be fixed relative to the housing without contacting the end walls, from which it remains spaced even in the final assembly state. The vertical end walls of the housing have central connecting pieces in which external connecting pipes can be fixed.

It is the object of the present invention to make a generic sound reducer lighter in weight and less expensive to manufacture.

### SUMMARY OF THE INVENTION

The above-stated object is achieved by a sound reducer comprising a housing having a jacket extending longitudinally along and rotationally symmetrical about a housing axis and further having two end walls aligned transverse to the housing axis. A main pipe penetrates the housing parallel to and offset from the housing axis with windows formed as pipe wall openings. The main pipe is sealingly fixed in passages penetrating the end walls. The sound reducer is characterized in that the end walls have a convex base curvature that is rotationally symmetrical with respect to the housing axis and, in the region of the passages, merge into outwardly pointing pipe sockets that project in one piece and in one material from the respective end wall. Each respective annular transition region is curved concavely in deviation from the convex base curvature with a radius that is at least 1/15 of the radius of the convex curvature of the base curvature.

The sound reducer disclosed herein is distinguished from the strictly cylindrical design of the housing. Instead of the vertical end walls of a cylinder, outwardly curved end walls are used in the sound reducer according to the invention. The overall shape of the housing is thus based on that of a pressure vessel. Accordingly, the structural internal pressure resistance of the housing is increased, which allows the choice of a thinner wall thickness compared to strictly cylindrical housings of the same overall pressure resistance. This results in lower material demand and thus lower cost and weight.

However, the shape of the housing cannot be completely matched to that of a pressure vessel. After all, the eccentric passage of the main pipe through the end walls is required, and the main pipe diameter is by no means small compared to the end wall diameter. A particular problem here is the eccentric arrangement of the passages, which are located between the center of the end wall and at a small distance from the edge of the end wall. In principle, it would be conceivable to provide an oval window in the curved end wall, through which the round main pipe would be positively guided and with whose edge its outer side would be welded. However, this would not simplify the manufacturing process but rather complicate it due to the more difficult drilling and welding conditions. On the other hand, pressure-sensitive areas would be created in the region where the end wall and the main pipe meet at an acute angle. The pressure sensitive areas would have to be compensated either by increased material thickness or particularly thick weld seams, which would at least partially cancel out the material savings according to the invention explained at the beginning.

It is therefore a further aspect of the invention to form the passages as pipe sockets from the material of the end walls. The transition region between the end wall and the respective pipe socket is provided with comparatively large radii so that there are no acute angles susceptible to cracking. The pipe sockets project axially outwards so that the curvature of the transition area opposes the basic curvature of the end walls and breaks their symmetry in the area of the passages. Due to the avoidance of acute angles, however, the concept of thin material thicknesses can thus be consistently maintained. In addition, the inner walls of the pipe sockets provide a large area of contact with the outer wall of the main pipe, thereby making it possible to connect the main pipe to the pipe sockets in a purely friction-locked manner and, in particular, to press the main pipe into the pipe sockets in a clamped manner in order to achieve mechanical fixation and at the same time seal the interior of the housing or resonator. A welding of the main pipe to the housing can thus be dispensed with, so that the sound reducer according to the invention is not only lighter in weight but can also be manufactured more cost-effectively than sound reducers according to prior art.

The radius of the concave curvature of the transition area (between the pipe socket and the end wall) is preferably at least 1/15 of the radius of the convex curvature of the base curvature of the end walls. Due to the eccentric position of the pipe sockets in the end walls, which are basically rotationally symmetrical, the angle between the wall of the pipe socket concentric to the main pipe on the one hand and the tangent to the end wall on the other hand changes over the circumference of the passage. The most acute angle is at the point of the passage circumference closest to the center of the end wall. Thus, in the embodiment according to the invention, the section of the transition area with the smallest radius is located here. At this point, according to the preferred embodiment, it should have at least the mentioned value relative to the base curvature of the end wall. This ratio represents an optimum compromise between compressive strength and wall thickness. Significantly smaller radii lead to areas susceptible to cracking; significantly larger radii would necessitate increased material demand, in particular greater wall thicknesses.

The main pipe of some embodiments is fixed in the pipe socket in a clamping manner. In this way, the possibility of simplifying the manufacturing process created by the above explained design according to the invention is actually implemented. However, some embodiments may make some use of having the main pipe welded to the pipe socket in addition to the clamping fixation.

The skilled person will recognize that the sound reducer according to the invention is connected to further fluid lines in its final mounting position, for example in the exhaust system of a motor vehicle or in the refrigerant circuit of an air conditioning system. This connection is made in particular via the pipe sockets projecting axially outwards. Conveniently, these pipe sockets project axially outwards beyond the ends of the main pipe which project into them from the inside. This makes it possible to insert fluid connection lines of the same caliber as the main pipe into the pipe sockets and to fix them there, in particular by clamping, but possibly also with (possibly additional) welding. With this design, the fluid is not disturbed by changes in the internal diameter of its line during its transition from the fluid connection line to the main pipe.

In some embodiments, at least one partition wall, through which the main pipe passes, is arranged in the housing. The partition wall may be aligned perpendicular to the housing axis and divides the housing interior into axial sections of different sizes. This at least one partition can be connected in a sealing manner to the outside of the main pipe and the inside of the jacket. However, variants of “seal-less” partition walls are also conceivable in which the partition wall has no sealing connection to the main pipe and/or the jacket. In such a case, the partition wall can be designed, for example, as a web surrounding the main pipe on the outside or the jacket on the inside. The provision of one or more sealing partition walls as well as one or more seal-less partition walls in one and the same sound reducer is also possible and may be useful in special applications. As explained at the beginning, the subdivision of the housing interior into several resonator chambers separated from each other (sealing partition wall) or connected to each other in a fluid-conducting manner (seal-less partition wall) can be used to broaden the sound reduction spectrum.

The partition wall may be frictionally connected to the main pipe, in particular the partition wall may be pressed onto the main pipe with an eccentrically arranged through-opening. However, it is also possible to additionally realize a positive axial fixation. For this purpose, in a further development of the invention, the main pipe has a radial projection at least on one side of the partition wall and axially abutting the partition wall. The radial projection fixes the partition wall on the main pipe axially in a form-fitting manner. The projection can be a single projection, a circumferential ring or a plurality of projections distributed annularly over the outer circumference of the main pipe. For process engineering implementation, the partition wall is advantageously first pressed onto the main pipe. The main pipe is then provided with the radial projection axially adjacent to the partition wall. This can be done, for example, by crimping or compressing the pipe. It is conceivable that this produces a bidirectionally effective, positive axial fixation of the partition wall, i.e. the projection or projections are produced on both sides of the partition wall after pressing on. Alternatively, it is conceivable to provide the main pipe with a projection or a set of projections already before the partition wall is pressed on, which serve as a stop for the pressing-on process, and to probably subsequently generate one or more additional projections on the other side of the partition wall. Alternatively, an only unidirectionally acting, positive axial fixation is also possible.

As mentioned, in certain embodiments the outer edge of the partition wall rests against the inside of the housing jacket—in particular sealingly, but possibly also seal-less—in order to divide the housing interior into two separate resonator chambers. For sealing purposes, the edge of the partition wall can be provided with appropriate sealing elements. However, it is also conceivable to have the edge of the partition wall friction-locked to the inner wall of the housing. In particular, the latter variant is supported by a preferred shape of the housing, the jacket of which preferably tapers conically towards its axial ends. In this embodiment, it is in fact possible, by varying the axial position of the partition wall relative to the main pipe or together with the main pipe relative to the housing, to influence the contact force with which the partition wall edge abuts against the conical region of the housing. In particular, the partition wall can be pushed against the tapering slope of the conical area to such an extent that its edge is securely in frictional sealing contact.

The housing of some embodiments is composed of two preferably identically shaped half-shells that are tightly joined, in particular welded, along their shell edges. Such half-shells can be products of a deep-drawing process. Preferred materials for the half-shells and/or the main pipe and/or the partition wall are metal, but in special applications also plastic.

The particular advantage of constructing the housing from two half-shells lies in the manufacturing process. Such a process comprises the steps of: providing the two half shells; providing the main pipe with the partition wall through which the main pipe passes, so that the partition wall is connected sealingly to the outside of its pipe wall and is aligned perpendicular to the pipe axis; clampingly inserting the ends of the main pipe into the respective one of the pipe sockets of the half shells so that their shell edges come into contact with one another, and with the outer edge of the partition wall abutting against the inner wall of one of the half shells; and sealing the shell edges together.

In the case of an outwardly tapering housing jacket, that end of the main pipe that is closer to the partition wall can be inserted into the pipe socket of the half-shell associated with it to such an extent that the outer edge of the partition wall abuts against the inner wall of the conical region of this half-shell—preferably in a sealing and friction-locking manner. Alternatively or additionally, a form-fit can be provided and is effected by the inner wall of the half-shell having an undercut-free stop in the abutment area. This stop can be formed in particular by an annular base running around the entire circumference of the half-shell on the inside. The freedom from undercuts of this base is helpful in order to be able to produce the half-shell as part of a deep-drawing process, as is preferably provided.

Further details and advantages of the invention will be apparent from the following specific description and drawings.

### BRIEF DESCRIPTION OF THE DRAWINGS

FIG. 1 is a perspective view of a sound reducer according to the invention.

FIG. 2 is a longitudinal section through the sound reducer of FIG. 1.

FIGS. 3a-3g are cross-sections through the sound reducer of FIGS. 1 and 2 taken along the sectional planes IIIa to IIIg in FIG. 2.

### DETAILED DESCRIPTION

Identical reference signs in the figures indicate identical or analogous elements.

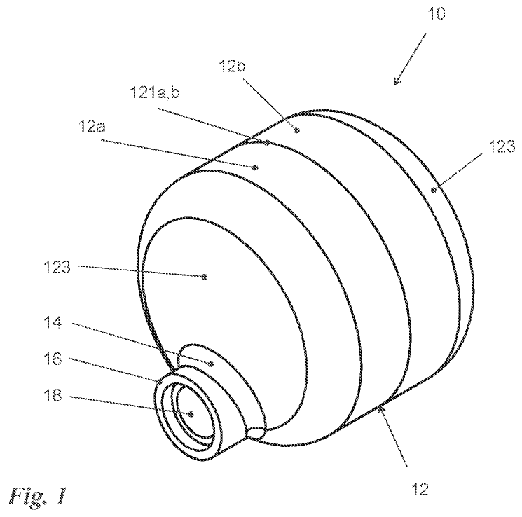

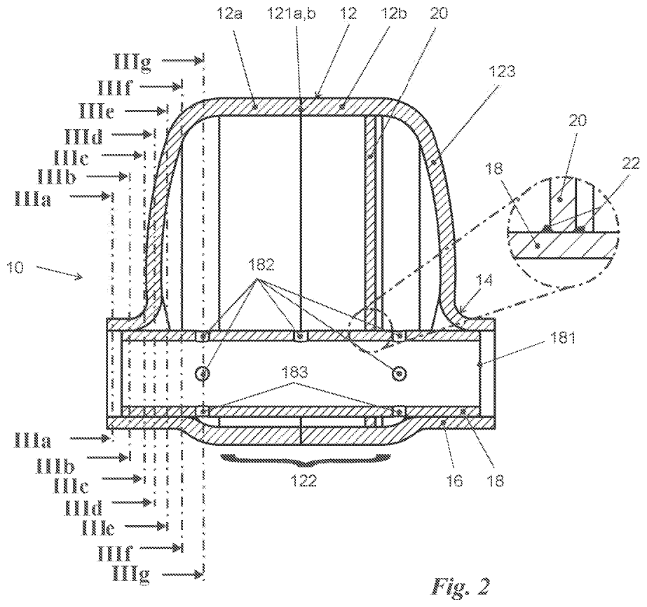

FIG. 1 is a perspective view of a sound reducer 10 according to the invention, the construction of which can be explained more clearly on the basis of the longitudinal section of FIG. 2, which shows the sound reducer 10 in its approximate final installation orientation. The sound reducer 10 comprises a housing 12 that is constructed from two half-shells 12a, 12b of identical shape in the present embodiment. The half-shells 12a, 12b abut each other with their circular shell edges 121a, b and are welded together along this seam. The half-shells 12a, 12b are formed in such a way that the housing 12 has a rotationally symmetrical jacket 122 in its axial center region. In the embodiment of FIG. 2, the jacket 122 is exactly cylindrical in shape. Laterally adjoining the jacket 122 are end walls 123 that have a convex base curvature, i.e. curved towards the exterior of the housing. This base curvature is also rotationally symmetrical.

However, the rotational symmetry of the end walls 123 is broken in an off-center (bottom of the figures) region by the fact that the end walls 123 transition, via a concavely curved transition region 14, into pipe sockets 16 that form passages through the end walls 123 that are coaxial with each other and offset parallel to the axis of symmetry of the jacket 122.

The housing 12 is penetrated by a main pipe 18 that is fixed with its ends 181 in a force-fit, in particular clamping, manner in one of the respective pipe sockets 16. The frictional connection acts fully around the circumference of the main pipe 18, so that the passages formed by the pipe sockets 16 into the interior of the housing are thereby sealed. In the embodiment shown, the pipe sockets 16 project axially outward beyond the ends 181 of the main pipe 18. In this area, supply lines adapted in circumference to the main pipe 18 can be fixed by clamping and/or by material-fit (e.g. welding or bonding).

The wall of the main pipe 18 comprises several apertures that connect its interior with the interior of the housing in a fluid-conducting manner. The openings have different functions. The windows 182 arranged at the top and sides of the main pipe 18 in FIG. 2 allow sound waves to enter the interior of the housing, which acts as a resonator chamber. The holes 183 arranged at the bottom in FIG. 2, on the other hand, serve to extract liquid that may accumulate in the lower region of the resonator chamber and that is extracted due to the jet pump effect of the fluid flowing through the main pipe 18.

In the embodiment shown, the interior of the housing is divided into two separate resonator chambers by a partition wall 20. The partition wall 20 is in sealing contact with the main pipe 18 by which it is penetrated on the one hand, and with the inner wall of the jacket 122 on the other hand. Both sealing attachments preferably are made in a force-fit manner. However, a form fit is possible alternatively or preferably additionally. In the embodiment shown, this is realized in the area where the partition wall 20 abuts against the main pipe 18, as indicated by the magnifying window in FIG. 2. Here, the main pipe has radial projections 22 laterally of and adjacent to the partition wall 20, by means of which the axial position of the partition wall 20 is (additionally) secured.

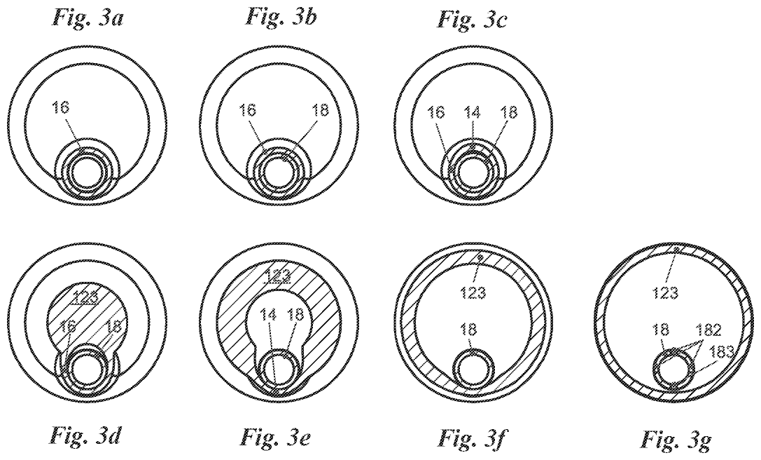

FIGS. 3a-3g show details of the concave transition area between pipe socket 16 and end wall 123 by means of seven cross-sections through the sound reducer of FIGS. 1 and 2 along section lines IIIa to IIIg in FIG. 2. The completely undercut-free shaping of the half shells 12a, 12b can be seen, which makes it possible to manufacture these components as deep-drawn elements.

In the preferred manufacturing process, the partition wall 20 is first pressed onto the main pipe 18. For this purpose, a radial projection 22 previously applied to the main pipe 18 can serve as a stop for the press-on process. However, it is also possible to position the partition wall 20 precisely axially without such a radial projection. Then, on the other side of the pressed-on partition wall, a (further) radial projection 22 can be produced, for example by crimping or compressing the main pipe 18, in order to additionally fix the pressed-on partition wall axially in a form-fitting manner. This (further) projection can also be dispensed with if the press-fitting process is appropriately designed. The assembly part consisting of the main pipe 18 and the partition wall 20 is then inserted into one of the half shells 12a, 12b, the front end of the main pipe 18 being inserted from the inside (i.e. from the later interior of the housing) into the corresponding pipe socket 16 and pressed therewith. In the cross-section of FIG. 2, the assembly part consisting of main pipe 18 and partition wall 20 preferably is inserted into the half shell 12b on the right in FIG. 2. In the process, the outer edge of the appropriately dimensioned partition wall 20 also comes into sealing, frictional contact with the inner wall of the shell 122, which can (not shown in FIG. 2) be provided here with a stop to improve the sealing contact. However, such a stop should preferably be designed to be free of undercuts with regard to the manufacturing process of the half-shells. In a subsequent step, the second half-shell is pushed onto the free, rear end of the main pipe 18 in an analogous manner until the shell edges 121a, b lie against each other and can be welded together.

To connect the sound reducer 10 to a fluid line system, for example to the exhaust line of a motor vehicle or the refrigerant line of an air conditioning system, connection pipes on the system side can be inserted into the projecting areas of the pipe sockets and fixed there with a force fit and/or material bond. The inner and outer diameters of the connecting pipes preferably correspond to the inner and outer diameters of the main pipe 18 so that the flowing fluid has a constant channel diameter.

Of course, the embodiments discussed in the specific description and shown in the figures are only illustrative examples of embodiments of the present invention. One skilled in the art is provided with a wide range of possible variations in light of the present disclosure. In particular, it is not mandatory to make the jacket 122 cylindrical, as shown. In particular, with respect to a sealing abutment of the partition wall 20 against the inner wall of the jacket, it may be favorable to select a jacket shape that tapers conically toward the axially outward directions. Such a design also simplifies the formation of undercut-free stops for the abutment of the partition wall 20 against the inner side of the jacket 122.

### LIST OF REFERENCE SIGNS

10 sound reducer
12 housing
12a, b half shells
121a, b shell edges
122 jacket
123 end wall
14 transition region
16 pipe socket
18 main pipe
181 end of 18
182 windows
183 hole
20 partition wall
22 radial projection

1. A sound reducer (10), comprising:
a housing (12) having a jacket (122) extending longitudinally along and rotationally symmetrical about a housing axis and further having two end walls (123) aligned transversely to the housing axis, and
a main pipe (18) penetrating the housing (12) parallel offset to the housing axis with windows (182) formed as pipe wall openings, the main pipe (20) being sealingly fixed in passages penetrating the end walls (123),
wherein the end walls (123) have a convex base curvature that is rotationally symmetrical with respect to the housing axis and, in a region of the passages, merge into outwardly pointing pipe sockets (16) that project in one piece and in one material from the respective end wall (123), respective annular transition region (14) between the pipe sockets (16) and the end walls (123) being curved concavely in deviation from the convex base curvature with a radius that is at least 1/15 of a radius of the convex curvature of the base curvature.

2. The sound reducer (10) of claim 1,
wherein the main pipe (18) is fixed in a clamping manner in the pipe socket (16).

3. The sound reducer (10) of claim 1, wherein the main pipe (18) is welded to the pipe sockets (16).

4. The sound reducer (10) of claim 1, wherein the pipe sockets (16) project axially outwards beyond ends (181) of the main pipe (18) and the ends (181) of the main pipe (18) projecting into the pipe sockets (16).

5. The sound reducer (10) of claim 1, further comprising at least one partition wall (20) arranged in the housing (12), the at least one partition wall (20) being penetrated by the main pipe (18), the at least one partition wall (20) being aligned perpendicularly to the housing axis, and subdividing the housing interior into axial sections of different sizes.

6. The sound reducer (10) of claim 5, wherein the partition wall is sealingly connected to at least one of an outside of the main pipe (18) and an inside of the jacket (122).

7. The sound reducer (10) of claim 5, wherein the partition wall (20) is force-fittingly connected to the main pipe (18) and is pressed onto the main pipe (18) by means of an eccentrically arranged through opening.

8. The sound reducer (10) of claim 7,
wherein the main pipe (18) has, at least on one side of the partition wall (20) and axially abutting the partition wall (20), a radial projection (22) fixes the partition wall (20) on the main pipe (18) axially in a form-fitting manner.

9. The sound reducer (10) of claim 1, wherein the jacket tapers conically towards its axial ends.

10. The sound reducer (10) of claim 1, wherein the housing (12) is composed of two half shells (12a, 12b) that are connected tightly to one another along their shell edges (121a, 121b).

11. The sound reducer (10) of claim 10, wherein the half-shells (12a, 12b) are products of a deep-drawing process.

12. A method of manufacturing a sound reducer (10), comprising the steps of:
providing the two half shells (12a, 12b),
providing a main pipe (18) with a partition wall (20) through which the main pipe (18) passes, with the partition wall (20) being sealingly connected to an outside of a pipe wall of the main pipe (18) and aligned perpendicular to a pipe axis of the main pipe (18),
clampingly inserting ends (181) of the main pipe (18) into respective pipe sockets (16) of the half shells (12a, 12b) so that shell edges (121a, 121b) of the half shells (12a, 12b) come into contact with one another, and so that an outer edge of the partition wall (20) abut against inner surface of one of the half shells (12b), and
sealing the shell edges (121a, 121b) together.

13. The method claim 12, wherein:
an end of the main pipe that is closer to the partition wall is inserted into the pipe socket of the associated half-shell to such an extent that the outer edge of the partition wall abuts against an inner wall of a conical region of this half-shell.

14. The method according of claim 13, wherein the inner surface of the half shell has an undercut-free stop in the abutment region.

15. The method of claim 12, wherein the partition wall (20) is first pressed onto the main pipe (18), and the main pipe (18) is provided with at least one radial projection (22) axially abutting the partition wall (20).
